(19) United States
(12) Patent Application Publication
(10) Pub. No.: US 2014/0267962 A1
(43) Pub. Date: Sep. 18, 2014

(54) LIQUID CRYSTAL DISPLAY

(71) Applicant: SAMSUNG DISPLAY CO., LTD., YONGIN-CITY (KR)

(72) Inventors: JAE HOON JUNG, ANYANG-SI (KR); SU JEONG KIM, SEOUL (KR); HYO SIK KIM, YONGIN-SI (KR); HOON KIM, ANSAN-SI (KR); KI CHUL SHIN, SEONGNAM-SI (KR); DAN BI YANG, GUNPO-SI (KR); MIN JU HAN, SEOUL (KR); JI PHYO HONG, PYEONGTAEK-SI (KR)

(73) Assignee: SAMSUNG DISPLAY CO., LTD., YONGIN-CITY (KR)

(21) Appl. No.: 14/067,394

(22) Filed: Oct. 30, 2013

(30) Foreign Application Priority Data
Mar. 12, 2013 (KR) 10-2013-0026331

(51) Int. Cl. G02F 1/1343

(52) U.S. Cl. CPC G02F 1/134309
USPC 349/33

(57) ABSTRACT

A liquid crystal display according to an exemplary embodiment of the present disclosure includes a gate line positioned on a first substrate; a data line positioned on the first substrate that crosses the gate line and includes a first data line and a second data line which are positioned at the left and right for every unit pixel, respectively; and a shielding electrode that extends parallel to the data line and overlaps a portion between the second data line of the first pixel and the first data line of the second pixel. The unit pixel includes a first pixel and a second pixel adjacent to the first pixel and the second data line of the first pixel is adjacent to the first data line of the second pixel.

### CROSS-REFERENCE TO RELATED APPLICATION

This application claims priority under 35 U.S.C. 119 from Korean Patent Application No. 10-2013-0026331 filed in the Korean Intellectual Property Office on Mar. 12, 2013, and all the benefits accruing therefrom, the contents of which are herein incorporated by reference in their entirety.

### BACKGROUND

(a) Technical Field

Embodiments of the present disclosure are directed to a liquid crystal display.

(b) Discussion of the Related Art

A liquid crystal display is one of the most common types of flat panel displays currently in use, and typically includes two sheets of display panels upon which field generating electrodes, such as a pixel electrode and a common electrode, are disposed and a liquid crystal layer interposed therebetween.

A liquid crystal display generates an electric field in the liquid crystal layer by applying voltages to the field generating electrodes, which generate an electric field that and determines orientations of the liquid crystal molecules of the liquid crystal layer, thus controlling polarization of incident light so as to display images.

A liquid crystal display also typically includes a switching element or thin film transistor connected to each pixel electrode, and a plurality of signal lines, such as a gate line and a data line, by which the switching element applies a voltage to the pixel electrode.

Among liquid crystal displays, vertically aligned mode liquid crystal displays, in which long axes of the liquid crystal molecules are vertically aligned with respect to the display panels when no electric field is applied, has become more common because of their high contrast ratio and a wide reference viewing angle.

In a vertically aligned mode liquid crystal display, for side visibility to approximate to front visibility, a method of dividing one pixel into two subpixels and applying different voltages to the two subpixels to vary transmittance has been suggested.

However, when one pixel is divided into two subpixels, the transmittance of the two subpixels is changed so that the side visibility approximates to the front visibility, luminance may increase in a low gray scale or a high gray scale, which affects gray scale display at the side and which may deteriorate image quality.

In addition, as liquid crystal display resolution has increased, pixel size needs to be reduced to increase the number of same size pixels disposed on a substrate. However, since there are limits to how much a structure such as a thin film transistor may be reduced, a reduction in a pixel area may lead to a decrease in aperture ratio or transmittance.

### SUMMARY

Embodiments of the present disclosure provide a liquid crystal display having improved visibility, a more exact display of a gray scale in a low gray scale region, and an enhanced aperture ratio or transmittance.

An exemplary embodiment of the present disclosure provides a liquid crystal display including: a gate line positioned on a first substrate; a data line positioned on the first substrate that crosses the gate line and includes a first data line and a second data line which are positioned at the left and right for every unit pixel, respectively, wherein the unit pixel includes a first pixel and a second pixel adjacent to the first pixel and the second data line of the first pixel is adjacent to the first data line of the second pixel; and; a shielding electrode positioned that extends parallel to the data line and overlaps a portion of the second data line of the first pixel and the first data line of the second pixel.

The liquid crystal display may further include a first subpixel electrode positioned on the first substrate and provided with a first voltage; a second subpixel electrode positioned on the first substrate and provided with a second voltage; and an insulating layer positioned between the first subpixel electrode and the second subpixel electrode. At least a part of the first subpixel electrode may be positioned below the insulating layer and the second subpixel electrode may be positioned on the insulating layer.

The shielding electrode may be formed in the same layer as and of a same material as the first subpixel electrode, and may be covered by the insulating layer

Signals having different polarities may be provided to the second data line of the first pixel and the first data line of the second pixel.

The liquid crystal display may further include a second substrate facing the first substrate; a liquid crystal layer interposed between the first substrate and the second substrate and including liquid crystal molecules; and a common electrode positioned on the second substrate and provided with a common voltage.

A difference between the first voltage and the common voltage may be larger than a difference between the second voltage and the common voltage.

A first portion of the first subpixel electrode and a second portion of the second subpixel electrode may overlap with the insulating layer therebetween.

The first portion of the first subpixel electrode may include a first subregion positioned below the insulating layer and a second subregion positioned on the insulating layer, and the first subregion and the second subregion may be connected through a contact hole formed in the insulating layer.

The second portion of the second subpixel electrode may include a plurality of branch electrodes extending in a plurality of different directions.

A part of the second subpixel electrode except for the second portion may have a planar shape.

Another exemplary embodiment of the present disclosure provides a liquid crystal display including: a first substrate; a first subpixel electrode positioned on the first substrate and provided with a first voltage; a second subpixel electrode positioned on the first substrate and provided with a second voltage; and an insulating layer positioned between the first subpixel electrode and the second subpixel electrode. The first subpixel electrode includes a first portion that includes a first subregion positioned below the insulating layer and a second subregion positioned on the insulating layer, and the first subregion and the second subregion are connected through a contact hole formed in the insulating layer.

The second subpixel electrode may include a second portion that includes a plurality of branch electrodes extending in a plurality of different directions.

The first portion of the first subpixel electrode and the second portion of the second subpixel electrode may overlap with the insulating layer therebetween.

The second subpixel electrode may be positioned on the insulating layer.

A part of the second subpixel electrode except for the second portion may have a planar shape.

The liquid crystal display may further include: a gate line positioned on the first substrate; a data line positioned on the first substrate and crossing the gate line that includes a first data line and a second data line respectively positioned at the left and right for every unit pixel; and a shielding electrode positioned at a same layer as the first subpixel electrode that overlaps the data line and is covered by the insulating layer.

The unit pixel may include a first pixel and a second pixel adjacent to the first pixel, the second data line of the first pixel may be adjacent to the first data line of the second pixel, and the shielding electrode may extend parallel to the data line and may overlap a portion between the second data line of the first pixel and the first data line of the second pixel.

The shielding electrode may be formed of a same material as the first subpixel electrode.

The liquid crystal display may further include: a second substrate facing the first substrate; a liquid crystal layer interposed between the first substrate and the second substrate and including liquid crystal molecules, and a common electrode positioned on the second substrate that is provided with a common voltage. A difference between the first voltage and the common voltage may be larger than a difference between the second voltage and the common voltage.

According to an exemplary embodiment of the present disclosure, a first subpixel electrode provided with a first voltage and a second subpixel electrode provided with a second voltage are formed and a part of the first subpixel electrode overlaps a part of the second subpixel electrode so that one pixel area is divided into a first region where the first subpixel electrode is positioned, a second region where the first subpixel electrode overlaps the second subpixel electrode, and a third region where the second subpixel electrode is positioned, thereby allowing side visibility to approximate the front visibility, exactly displaying a gray scale in a low gray scale region, and preventing deterioration in transmittance which may occur in a region between the first subpixel electrode and the second subpixel electrode.

Further, according to an exemplary embodiment of the present disclosure, it is possible to suppress generation of parasitic capacitance, which may occur between the pixel electrode and the data line, by forming a shielding electrode that overlaps the data line. Therefore, it is possible to reduce a separation distance between the pixel electrode and the data line, to improve an overall aperture ratio.

Moreover, according to an exemplary embodiment of the present disclosure, there is provided a structure in which an insulating layer covers the shielding electrode to prevent electrodes positioned on the upper and lower panels from being shorted.

### BRIEF DESCRIPTION OF THE DRAWINGS

FIG. 1 is a layout view of a liquid crystal display according to an exemplary embodiment of the present disclosure.

FIG. 2 is a cross-sectional view of the liquid crystal display FIG. 1 taken along line II-II.

FIG. 3 is a layout view of a first subpixel electrode of the liquid crystal display of FIG. 1.

FIG. 4 is a layout view of a part of the first subpixel electrode and a second subpixel electrode of the liquid crystal display of FIG. 1.

FIG. 5 is a cross-sectional view of the liquid crystal display of FIG. 1 taken along line V-V.

FIG. 6 is a cross-sectional view of the liquid crystal display of FIG. 1 taken along line VI-VI.

FIG. 7 is a cross-sectional view of the liquid crystal display of FIG. 1 taken along line VII-VII.

FIG. 8 is a cross-sectional view of the liquid crystal display of FIG. 1 taken along line VIII-VIII.

FIG. 9 is a layout view of a liquid crystal display according to an exemplary embodiment of the present disclosure.

FIG. 10 is a cross-sectional view of the liquid crystal display of FIG. 9 taken along line X-X.

### DETAILED DESCRIPTION OF THE EMBODIMENTS

Hereinafter, exemplary embodiments of the present disclosure will be described in detail with reference to the accompanying drawings. As those skilled in the art would realize, the described embodiments may be modified in various different ways, all without departing from the spirit or scope of the present disclosure.

In the drawings, the thickness of layers, films, panels, regions, etc., are exaggerated for clarity. It will be understood that when a layer is referred to as being “on” another layer or substrate, it can be directly on the other layer or substrate, or intervening them may also be present. Like reference numerals designate like elements throughout the specification.

Hereinafter, a liquid crystal display according to an exemplary embodiment of the present disclosure will be described with reference to FIGS. 1 to 8. FIG. 1 is a layout view of a liquid crystal display according to an exemplary embodiment of the present disclosure. FIG. 2 is a cross-sectional view of the liquid crystal display FIG. 1 taken along line FIG. 3 is a layout view of a first subpixel electrode of the liquid crystal display of FIG. 1. FIG. 4 is a layout view of a part of the first subpixel electrode and a second subpixel electrode of the liquid crystal display of FIG. 1. FIG. 5 is a cross-sectional view of the liquid crystal display of FIG. 1 taken along line V-V. FIG. 6 is a cross-sectional view of the liquid crystal display of FIG. 1 taken along line VI-VI. FIG. 7 is a cross-sectional view of the liquid crystal display of FIG. 1 taken along line VII-VII. FIG. 8 is a cross-sectional view of the liquid crystal display of FIG. 1 taken along line VIII-VIII.

First, referring to FIGS. 1 and 2, a liquid crystal display according to a present exemplary embodiment includes a lower panel 100 and an upper panel 200 which face each other and a liquid crystal layer 3 interposed between the two display panels 100 and 200.

First, a lower panel 100 will be described.

A gate line 121, a reference voltage line 131, and a storage electrode 135 are disposed on an insulation substrate 110 that is made of transparent glass or plastic. The gate line 121 mainly extends in a horizontal direction to transfer a gate signal.

The gate line 121 includes a wide end portion (not illustrated) for connection with a first gate electrode 124a, a second gate electrode 124b, a third gate electrode 124c, and another layer or an external driving circuit.

The reference voltage line 131 may extend parallel to the gate line 121, and has an extension portion 136 which is connected to a third drain electrode 175c to be described below.

The reference voltage line 131 includes a storage electrode 135 that surrounds a pixel area.

A gate insulating layer 140 is disposed on the gate line 121, the reference voltage line 131, and the storage electrode 135.

A first semiconductor 154a, a second semiconductor 154b, and a third semiconductor 154c, which may be made of amorphous or crystalline silicon, are disposed on the gate insulating layer 140. Further, a semiconductor stripe (not shown) is disposed below a data line 171 which will be described below.

A plurality of ohmic contacts 163a, 163b, 163c, 165a, and 165b are disposed on the first semiconductor 154a, the second semiconductor 154b, and the third semiconductor 154c. A linear ohmic contact (not shown) may be disposed below the data line 171. When the semiconductors 154a, 154b, and 154c are oxide semiconductors, the ohmic contacts may be omitted.

A data conductor 171, 173a, 173b, 173c, 175a, 175b, and 175c that includes the data line 171 that extends is a vertical direction perpendicular to the horizontal direction, a first source electrode 173a, a second source electrode 173b, a first drain electrode 175a, a second drain electrode 175b, a third source electrode 173a, and a third drain electrode 175c, is disposed on the ohmic contacts 163a, 163b, 163c, 165a, and 165b and the gate insulating layer 140. In a present exemplary embodiment, the data line 171 includes a first data line 171a and a second data line 171b which are positioned at the left and the right of a unit pixel, respectively. In the layout view illustrated in FIG. 1, a left pixel is referred to as a first pixel and a right pixel is referred to as a second pixel, the second data line 171b of the first pixel and the first data line 171a of the second pixel are adjacent to each other. Further, signals that have different polarities may be applied to the data line 171 of the first pixel and the data line 171 of the second pixel.

The second drain electrode 175b is connected to the third source electrode 173c.

The first gate electrode 124a, the first source electrode 173a, and the first drain electrode 175a together with the first semiconductor 154a form a first thin film transistor Qa, and a channel of the thin film transistor is formed in the semiconductor portion 154a between the first source electrode 173a and the first drain electrode 175a. Similarly, the second gate electrode 124b, the second source electrode 173b, and the second drain electrode 175b together with the second semiconductor 154b form a second thin film transistor Qb, and a channel of the thin film transistor is formed in the semiconductor portion 154b between the second source electrode 173b and the second drain electrode 175b. In addition, the third gate electrode 124c, the third source electrode 173c, and the third drain electrode 175c together with the third semiconductor 154c form a third thin film transistor Qc, and a channel of the thin film transistor is formed in the semiconductor portion 154c between the third source electrode 173c and the third drain electrode 175c.

A first passivation layer 180a, which may be made of an inorganic insulator such as silicon nitride or silicon oxide, is disposed on the data conductor 171, 173a, 173b, 173c, 175a, 175b, and 175c and exposed portions of the semiconductors 154a, 154b, and 154c.

A color filter 230 is positioned on the first passivation layer 180a.

A light blocking member (not illustrated) may be positioned on a region that lacks the color filter 230 and may overlap part of the color filter 230. The light blocking member is also called a black matrix and prevents light leakage.

A first overcoat (capping layer) 80 is positioned on the color filter 230. The first overcoat 80 prevents the color filter 230 from separating and may prevent contamination of the liquid crystal layer 3 due to organic materials such as a solvent seeping in from the color filter, thus preventing defects such as afterimages which may occur when a screen is driven.

A first subregion 191a1 of a first subpixel electrode 191a is disposed on the first overcoat 80.

Referring to FIG. 3, the first subregion 191a1 of the first subpixel electrode 191a has a planar shape that includes a cross-shaped connection portion positioned at the center of the pixel area and four parallelograms positioned around the cross-shaped connection portion to surround the cross-shaped connection portion. A first extension portion 193 is positioned at the center of the cross-shaped connection portion. Further, another protrusion extends upward and downward from a horizontal center of the pixel area. As such, the first subregion 191a1 of the first subpixel electrode 191a is positioned in a part of the pixel area.

In addition, in an exemplary embodiment of the present disclosure, a shielding electrode 195 is disposed on the same layer as the first subpixel electrode 191a. Like the first subpixel electrode 191a, the shielding electrode 195 may be covered by a second passivation layer 180b. The shielding electrode 195 may extend in a same direction as the data line 171. Further, the shielding electrode 195 overlaps a portion between the second data line 171b of the first pixel and the first data line 171a of the second pixel in a plan view. In additional, the shielding electrode 195 may overlap an edge of the second data line 171b of the first pixel and an edge of the first data line 171a of the second pixel.

The second passivation layer 180b is disposed on the first overcoat 80 and the first subregion 191a1 of the first subpixel electrode 191a.

A second subregion 191a2 of the first subpixel electrode 191a and the second subpixel electrode 191b are disposed on the second passivation layer 180b.

Referring to FIG. 4, the second subregion 191a2 of the first subpixel electrode 191a is positioned at the center of a pixel, and the overall shape thereof is a rhombus. The second subregion 191a2 of the first subpixel electrode 191a includes a cross-shaped stem portion that has a horizontal portion and a vertical portion and a plurality of first branch electrodes that extend diagonally from the cross-shaped stem portion. The first branch electrodes extend in four directions.

The second subpixel electrode 191b includes a third subregion 191b1 that overlaps the first subregion 191a1 of the first subpixel electrode 191a and a fourth subregion 191b2. The third subregion 191b1 overlaps the first subregion 191a1 with an insulating layer, in particular, the second passivation layer 180b, therebetween, and includes a plurality of second branch electrodes which extend in the same diagonal directions as the plurality of first branch electrodes of the second subregion 191a2.

The fourth subregion 191b2 includes a planar shape portion that has a trapezoid shape and a plurality of third branch electrodes which are positioned outside the planar shape portion and extend parallel to the plurality of second branch electrodes. The planar shape refers to a shape of an original undivided plate.

A first contact hole 185a is formed in the first passivation layer 180a and the first overcoat 80 to expose a part of the first drain electrode 175a, and a second contact hole 185b is formed in the first passivation layer 180a, the first overcoat 80, and the second passivation layer 180b to expose a part of the second drain electrode 175b. Further, a third contact hole 186 is formed in the second passivation layer 180b to expose the center of the first subregion 191a1.

The first subregion 191a1 physically and electrically connects to the first drain electrode 175a through the first contact hole 185a, and the second subpixel electrode 191b physically and electrically connects to the second drain electrode 175b through the second contact hole 185b. Further, the second subregion 191a2 connects to the extension portion 193 of the first subregion 191a1 through the third contact hole 186 in the second passivation layer 180b.

The first subpixel electrode 191a and the second subpixel electrode 191b receive data voltages through the first contact hole 185a and the second contact hole 185b from the first drain electrode 175a and the second drain electrode 175b, respectively.

Now, the upper panel 200 will be described.

A light blocking member 220, a second overcoat 250, and a common electrode 270 are disposed on an insulation substrate 210 made of transparent glass or plastic.

However, in a liquid crystal display according to another exemplary embodiment of the present disclosure, the light blocking member 220 may be positioned on the lower panel 100, and in a liquid crystal display according to another exemplary embodiment of the present disclosure, the color filter may be positioned on the upper panel 200.

Alignment layers (not illustrated) are disposed on inner surfaces of the display panels 100 and 200 and may be vertical alignment layers.

Polarizers (not illustrated) are provided on outer surfaces of the two display panels 100 and 200. Transmissive axes of two polarizers are orthogonal to each other and one transmissive axis may be parallel to the gate line 121. However, according to another exemplary embodiment a single polarizer may be disposed on one of the outer surfaces of the two display panels 100 and 200.

The liquid crystal layer 3 has a negative dielectric anisotropy, and liquid crystal molecules of the liquid crystal layer 3 are aligned such that long axes thereof are vertical to the surfaces of the two display panels 100 and 200 in the absence of an electric field. Accordingly, in the absence of an electric field, incident light does not propagate through the crossed polarizers but is blocked.

At least one of the liquid crystal layer 3 and the alignment layer may include a photo-reactive material, such as reactive mesogen.

Hereinafter, a driving method of a liquid crystal display according to a present exemplary embodiment will be described in brief.

When a gate-on signal is provided to the gate line 121, the gate-on signal is applied to the first gate electrode 124a, the second gate electrode 124b, and the third gate electrode 124c, so that the first thin film transistor Qa, the second thin film transistor Qb, and the third thin film transistor Qc are turned on. Therefore, a data voltage provided to the data line 171 is applied to the first subpixel electrode 191a and the second subpixel electrode 191b through the turned-on first thin film transistor Qa and second thin film transistor Qb, respectively. In this case, the voltage applied to the first thin film transistor Qa and the second thin film transistor Qb has the same magnitude. However, the voltage applied to the second subpixel electrode 191b is divided through the third thin film transistor Qc which is connected to the second thin film transistor Qb in series. Accordingly, the voltage applied to the second subpixel electrode 191b is less than the voltage applied to the first subpixel electrode 191a.

Referring back to FIG. 1, a single pixel area of a liquid crystal display according to a present exemplary embodiment includes a first region R1 where the second subregion 191a2 is positioned, a second region R2 where a part of the first subregion 191a1 overlaps a part of the second subpixel electrode 191b, and a third region R3 where a part of the second subpixel electrode 191b is positioned.

Each of the first region R1, the second region R2, and the third region R3 has four subregions.

The area of the second region R2 may be approximately two times the area of the first region R1, and the area of the third region R3 may be approximately two times the area of the second region R2.

Now, referring to FIGS. 5 to 7, the first region R1, the second region R2, and the third region R3 included in a pixel area of the liquid crystal display according to the present exemplary embodiment will be described.

Referring to FIG. 5, the first region R1 of a pixel area of a liquid crystal display according to a present exemplary embodiment is positioned on the lower panel 100, and the second subregion 191a2 connected to the extension portion 193 and the common electrode 270 positioned on the upper panel 200 generate an electric field. As described above, the second subregion 191a2 includes a cross-shaped stem portion and a plurality of first branch electrodes extending in four different directions. The plurality of first branch electrodes may be inclined with respect to the gate line 121 by about 40 degrees to about 45 degrees. Liquid crystal molecules of the liquid crystal layer 3 positioned in the first region R1 are tilted in four different directions by a fringe field generated by edges of the plurality of first branch electrodes. More specifically, a horizontal component of the fringe field is substantially horizontal to sides of the plurality of first branch electrodes so that the liquid crystal molecules are inclined in a direction parallel to a longitudinal direction of the plurality of first branch electrodes.

Referring to FIG. 6, in the second region R2 of the a pixel area of a liquid crystal display according to a present exemplary embodiment, the third subregion 191b1 overlaps the first subregion 191a1. The liquid crystal molecules of the liquid crystal layer 3 are arranged by three electric fields: (1) the electric field formed between the first subregion 191a1 positioned among the plurality of second branch electrodes of the third subregion 191b2 and the common electrode 270; (2) the electric field formed between the third subregion 191b1 and the first subregion 191a1; together with (3) the electric field formed between the third subregion 191b1 and the common electrode 270 of the upper panel 200.

Next, referring to FIG. 7, in the third region R3 of a pixel area of a liquid crystal display according to a present exemplary embodiment, the fourth subregion 191b2 positioned on the lower panel 100 and the common electrode 270 positioned on the upper panel 200 generate an electric field. As described above, a part of the fourth subregion 191b2 has a planar shape and the other part includes a plurality of third branch electrodes. As such, the planar-shaped second subpixel electrode 191b is provided to increase transmittance of the liquid crystal display. A fringe field is formed by the plurality of second branch electrodes and the plurality of third branch electrodes. Liquid crystal molecules positioned at locations corresponding to the planar-shaped second subpixel electrode 191b are affected by liquid crystal molecules tilted by the fringe field so as to be tilted in longitudinal directions of the plurality of second branch electrodes and the plurality of third branch electrodes.

As described above, the magnitude of the second voltage applied to the second subpixel electrode 191b is less than the magnitude of the first voltage applied to the first subpixel electrode 191a.

Therefore, the intensity of the electric field applied to the liquid crystal layer in the first region R1 is the highest and the intensity of the electric field applied to the liquid crystal layer in the third region R3 is the lowest. Since the second region R2 is affected by the electric field of the first subpixel electrode 191a positioned below the second subpixel electrode 191b, the intensity of the electric field applied to the liquid crystal layer in the second region R2 is lower than that of the electric field in the first region R1 and higher than that of the electric field in the third region R3.

As such, in a liquid crystal display according to an exemplary embodiment of the present disclosure, a pixel area is divided into a first region that has a first subpixel electrode to which a relatively high first voltage is applied, a second region in which a part of the first subpixel electrode and a part of the second subpixel electrode overlap each other with the insulating layer therebetween, and a third region that has the second subpixel electrode to which a relatively low second voltage is applied. Therefore, the intensities of the electric fields applied to the liquid crystal molecules corresponding to the first region, the second region, and the third region differ, so that the angles at which the liquid crystal molecules are inclined differ, and thus luminance of each region varies. As such, when one pixel area is divided into three regions that have different luminances, transmittance changes due to gray scale changes may be prevented for both a low gray scale and a high gray scale by restricting transmittance changes due to the gray scale to be gradual. Thus, the side visibility may approximate the front visibility and the gray scale is displayed exactly for both a low gray scale and a high gray scale.

Referring to FIG. 8, the shielding electrode 195 is disposed at a location between the second data line 171b of the first pixel and the first data line 171a of the second pixel. Further, the shielding electrode 195 may be disposed where two adjacent color filters 230R and 230B overlap. The shielding electrode 195, as illustrated in FIG. 8, may be positioned on the same layer as the first subpixel electrode 191a and may be covered by the second passivation layer 180b.

The shielding electrode 195 disposed as described above may offset parasite capacitance between the first data line 171a and the second data line 171b and parasite capacitance between the first subpixel electrode 191a and the data line 171. Accordingly, a distance d1 between the adjacent first data line 171a and second data line 171b and a distance d2 between the first subpixel electrode 191a and the data line 171 may be reduced so that a width of the light blocking member 220 disposed on the upper panel 200 may be decreased. As a result, an aperture ratio or transmittance of the liquid crystal display may be increased. Further, the shielding electrode 195 according to a present exemplary embodiment is covered by the insulating layer positioned between the first subpixel electrode 191a and the second subpixel electrode 191b, which reduces a possibility of the shielding electrode 195 being shorted with the common electrode 270.

A liquid crystal display according to an above-mentioned exemplary embodiment is a vertically aligned mode liquid crystal display in which liquid crystal molecules are aligned by a vertical electric field generated between the pixel electrode 191 disposed on the lower panel 100 and the common electrode 270 disposed on the upper panel 200. However, embodiments of the present disclosure are not limited to a vertically aligned mode liquid crystal display, and the above-mentioned structural and functional characteristics of the shielding electrode 195 may be applicable to a plane to line switching (PLS) mode liquid crystal display in which both a planar first electrode and a linear second electrode are positioned on the lower panel with the insulating layer therebetween to generate an electric field to align the liquid crystal molecules, or an in-plane switching (IPS) mode liquid crystal display in which both a linear first electrode and a linear second electrode are positioned on the lower panel with the insulating layer therebetween to generate a horizontal electric field to align the liquid crystal molecules.

Specifically, in a PLS mode liquid crystal display or an IPS mode liquid crystal display, a shielding electrode may be disposed at the same position as that of the field generating electrode positioned below the insulating layer.

FIG. 9 is a layout view of a liquid crystal display according to an exemplary embodiment of the present disclosure. FIG. 10 is a cross-sectional view of the liquid crystal display of FIG. 9 taken along line X-X.

The liquid crystal display illustrated in FIGS. 9 and 10 is similar to the exemplary embodiment described with reference to FIGS. 1 to 8, except that one data line 171 may correspond to a unit pixel.

Referring to FIGS. 9 and 10, a shielding electrode 195 overlaps the single data line 171. The shielding electrode 195 may have a greater width than that of the data line 171.

The contents described with reference to FIGS. 1 to 8 may be mostly applied to the present exemplary embodiment except for the difference described above.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A liquid crystal display, comprising:
a gate line positioned on a first substrate;
a data line positioned on the first substrate that crosses the gate line and includes a first data line and a second data line which are positioned at the left and right for every unit pixel, respectively, wherein the unit pixel includes a first pixel and a second pixel adjacent to the first pixel and the second data line of the first pixel is adjacent to the first data line of the second pixel; and
a shielding electrode that extends parallel to the data line and overlaps a portion of the second data line of the first pixel and the first data line of the second pixel.

2. The liquid crystal display of claim 1, further comprising:
a first subpixel electrode positioned on the first substrate and provided with a first voltage;
a second subpixel electrode positioned on the first substrate and provided with a second voltage; and
an insulating layer positioned between the first subpixel electrode and the second subpixel electrode,
wherein at least a part of the first subpixel electrode is positioned below the insulating layer and the second subpixel electrode is positioned on the insulating layer.

3. The liquid crystal display of claim 2, wherein:
the shielding electrode is formed in the same layer as and of a same material as the first subpixel electrode, and is covered by the insulating layer.

4. The liquid crystal display of claim 1, wherein:
signals having different polarities are provided to the second data line of the first pixel and the first data line of the second pixel.

5. The liquid crystal display of claim 2, further comprising:
a second substrate facing the first substrate;
a liquid crystal layer interposed between the first substrate and the second substrate and including liquid crystal molecules; and
a common electrode positioned on the second substrate and provided with a common voltage.

6. The liquid crystal display of claim 5, wherein:
a difference between the first voltage and the common voltage is larger than a difference between the second voltage and the common voltage.

7. The liquid crystal display of claim 2, wherein:
a first portion of the first subpixel electrode and a second portion of the second subpixel electrode overlap with the insulating layer therebetween.

8. The liquid crystal display of claim 7, wherein:
the first portion of the first subpixel electrode includes a first subregion positioned below the insulating layer and a second subregion positioned on the insulating layer, and
the first subregion and the second subregion are connected through a contact hole formed in the insulating layer.

9. The liquid crystal display of claim 7, wherein:
the second portion of the second subpixel electrode includes a plurality of branch electrodes extending in a plurality of different directions.

10. The liquid crystal display of claim 9, wherein:
a part of the second subpixel electrode except for the second portion has a planar shape.

11. A liquid crystal display, comprising:
a first substrate;
a first subpixel electrode positioned on the first substrate and provided with a first voltage;
a second subpixel electrode positioned on the first substrate and provided with a second voltage; and
an insulating layer positioned between the first subpixel electrode and the second subpixel electrode;
wherein the first subpixel electrode includes a first portion that includes a first subregion positioned below the insulating layer and a second subregion positioned on the insulating layer, and the first subregion and the second subregion are connected through a contact hole formed in the insulating layer.

12. The liquid crystal display of claim 11, wherein:
the second subpixel electrode includes a second portion that includes a plurality of branch electrodes extending in a plurality of different directions.

13. The liquid crystal display of claim 12, wherein:
the first portion of the first subpixel electrode and the second portion of the second subpixel electrode overlap with the insulating layer therebetween.

14. The liquid crystal display of claim 11, wherein:
the second subpixel electrode is positioned on the insulating layer.

15. The liquid crystal display of claim 13, wherein:
a part of the second subpixel electrode except for the second portion has a planar shape.

16. The liquid crystal display of claim 11, further comprising:
a gate line positioned on the first substrate;
a data line positioned on the first substrate and crossing the gate line that includes a first data line and a second data line respectively positioned at the left and right for every unit pixel; and
a shielding electrode positioned at a same layer as the first subpixel electrode that overlaps the data line and is covered by the insulating layer.

17. The liquid crystal display of claim 16, wherein:
the unit pixel includes a first pixel and a second pixel adjacent to the first pixel,
the second data line of the first pixel is adjacent to the first data line of the second pixel, and
the shielding electrode extends parallel to the data line and overlaps a portion between the second data line of the first pixel and the first data line of the second pixel.

18. The liquid crystal display of claim 16, wherein:
the shielding electrode is formed of a same material as the first subpixel electrode.

19. The liquid crystal display of claim 11, further comprising:
a second substrate facing the first substrate;
a liquid crystal layer interposed between the first substrate and the second substrate and including liquid crystal molecules,
a common electrode positioned on the second substrate that is provided with a common voltage,
wherein a difference between the first voltage and the common voltage is larger than a difference between the second voltage and the common voltage.

20. A liquid crystal display, comprising:
a data line positioned on a first substrate;
a first subpixel electrode positioned on the first substrate that is configured to be provided with a first voltage;
a second subpixel electrode positioned on the first substrate that is configured to be provided with a second voltage;
an insulating layer positioned between the first subpixel electrode and the second subpixel electrode;
a shielding electrode positioned at a same layer as the first subpixel electrode that overlaps the data line and is covered by the insulating layer,
wherein a part of the first subpixel electrode overlaps a part of the second subpixel electrode wherein a pixel area is divided into a first region where the first subpixel electrode is positioned, a second region where the first subpixel electrode overlaps the second subpixel electrode, and a third region where the second subpixel electrode is positioned, wherein a side visibility of the pixel area is equivalent to a front visibility of the pixel area.
